(19) United States
(12) Patent Application Publication
(10) Pub. No.: US 2018/0126879 A1
(43) Pub. Date: May 10, 2018

(54) Vehicle Seat Propping Device

(71) Applicants: Mark Olsen, The Villages, FL (US); Larrie Yosha, The Villages, FL (US)

(72) Inventors: Mark Olsen, The Villages, FL (US); Larrie Yosha, The Villages, FL (US)

(21) Appl. No.: 15/347,303

(22) Filed: Nov. 9, 2016

(51) Int. Cl. B60N 2/44; F16B 5/02

(52) U.S. Cl. CPC B60N 2/44; F16B 5/02

(57) ABSTRACT

A vehicle seat propping device for propping a vehicle seat in a pivoted configuration includes a first plate that is configured to couple to an interior surface of a vehicle proximate to a hinged seat. A bar is hingedly coupled to and extends from the first plate. A grasp is coupled to the bar distal from the first plate. The grasp is configured to reversibly couple to a frame of the seat when the seat is pivoted. The grasp is configured to reversibly couple to the frame of the seat to prop the seat in a pivoted configuration. Hands-free access is permitted to objects that are positioned under the seat, such as a gas tank.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to propping devices and more particularly pertains to a new propping device for propping a vehicle seat in a pivoted configuration.

### BRIEF SUMMARY OF THE INVENTION

An embodiment of the disclosure meets the needs presented above by generally comprising a first plate that is configured to couple to an interior surface of a vehicle proximate to a hinged seat. A bar is hingedly coupled to and extends from the first plate. A grasp is coupled to the bar distal from the first plate. The grasp is configured to reversibly couple to a frame of the seat when the seat is pivoted. The grasp is configured to reversibly couple to the frame of the seat to prop the seat in a pivoted configuration. Hands-free access is permitted to objects that are positioned under the seat, such as a gas tank.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a vehicle seat propping device according to an embodiment of the disclosure.

FIG. 2 is a bottom view of an embodiment of the disclosure.

FIG. 3 is a side view of an embodiment of the disclosure.

FIG. 4 is a top view of an embodiment of the disclosure.

FIG. 5 is an in-use view of an embodiment of the disclosure.

FIG. 6 is a detail view of an embodiment of the disclosure.

FIG. 7 is a detail view of an embodiment of the disclosure.

### DETAILED DESCRIPTION OF THE INVENTION

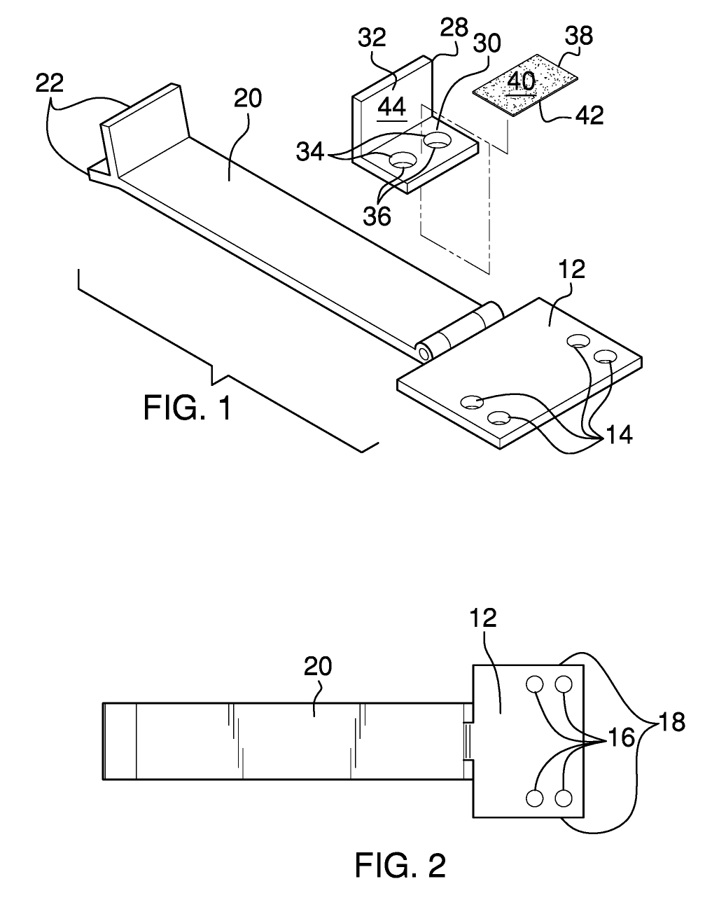

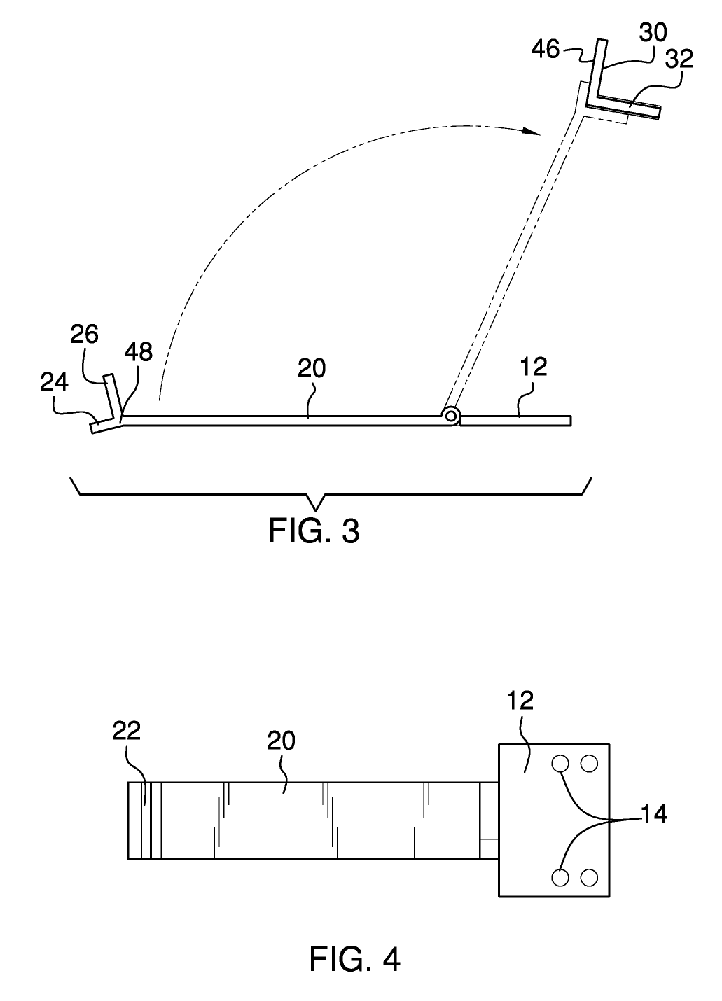

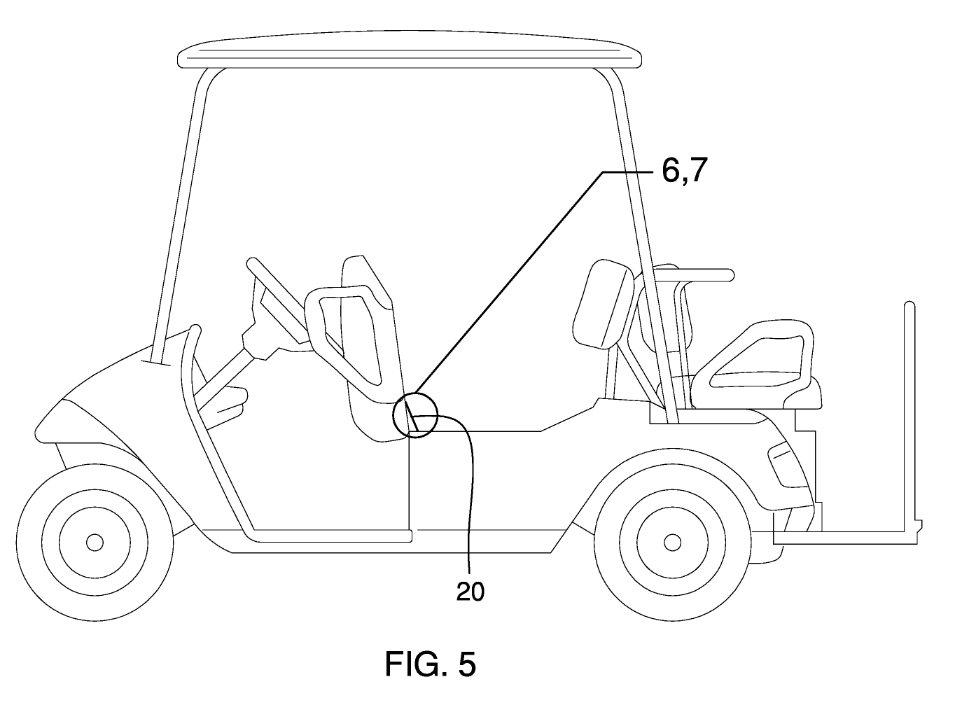

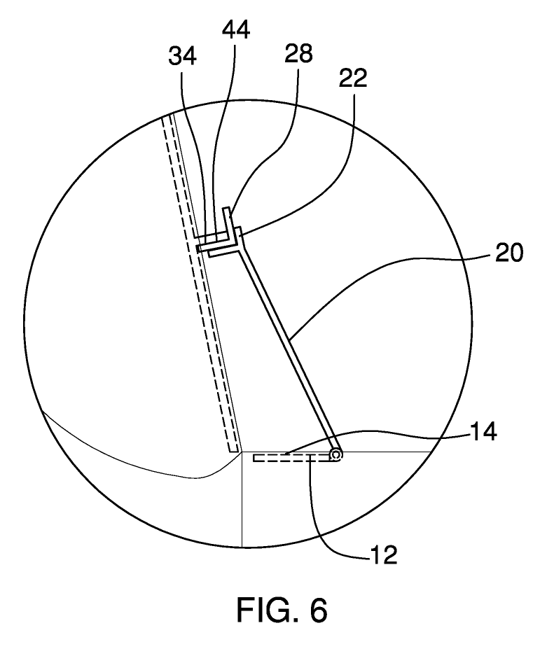

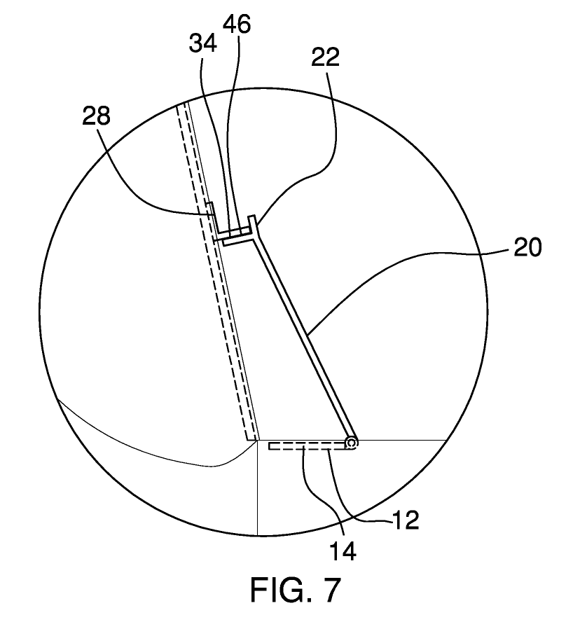

With reference now to the drawings, and in particular to FIGS. 1 through 7 thereof, a new propping device embodying the principles and concepts of an embodiment of the disclosure and generally designated by the reference numeral 10 will be described.

As best illustrated in FIGS. 1 through 7, the vehicle seat propping device 10 generally comprises a first plate 12 that is configured to couple to an interior surface of a vehicle proximate to a hinged seat. In one embodiment, the first plate 12 is substantially rectangularly shaped.

A coupler 14 is coupled to the first plate 12. The coupler 14 is configured to couple the first plate 12 to the interior surface of the vehicle. In one embodiment, the coupler 14 comprises a plurality of holes 16. The plurality of holes 16 is positioned through the first plate 12. The holes 16 are configured to accept mounting hardware, such as screws, to couple the first plate 12 to the interior surface of the vehicle. In another embodiment, the plurality of holes 16 comprises four holes 16 that are evenly distributed and are positioned proximate to respective opposing edges 18 of the first plate 12.

A bar 20 is hingedly coupled to and extends from the first plate 12. In one embodiment, the bar 20 is substantially elongated rectangularly shaped.

A grasp 22 is coupled to the bar 20 distal from the first plate 12. The grasp 22 is configured to reversibly couple to a frame of the seat when the seat is pivoted. The grasp 22 is configured to reversibly couple to the frame of the seat to prop the seat in a pivoted configuration. Hands-free access is thus permitted to objects that are positioned under the seat, such as a gas tank. In one embodiment, the grasp 22 comprises a second plate 24 that is coupled perpendicularly to a third plate 26. The bar 20 is coupled to and extends transversely from a junction 48 of the second plate 24 and the third plate 26.

In one embodiment, a bracket 28 is configured to couple to the frame of the seat. The bracket 28 is complementary to the grasp 22. The bracket 28 is positioned to reversibly couple to the grasp 22 to prop the seat in the pivoted configuration. In another embodiment, the bracket 28 comprises a fourth plate 30 that is coupled perpendicularly to a fifth plate 32.

A connector 34 is coupled to the bracket 28. The connector 34 is configured to couple the bracket 28 to the frame of the seat. In one embodiment, the connector 34 comprises a plurality of penetrations 36. The plurality of penetrations 36 is positioned through the bracket 28. The penetrations 36 are configured to accept mounting hardware, such as screws, to couple the bracket 28 to the frame of the seat. In another embodiment, the plurality of penetrations 36 comprises two penetrations 36 that are positioned in the fourth plate 30. In yet another embodiment, the connector 34 comprises tape 38 that has a first face 40 and a second face 42. The first face 40 and the second face 42 are adhesive. The first face 40 is selectively couplable to an inner face 44 and an outer face 46 of the bracket 28. The second face 42 is configured to couple the bracket 28 to the frame of the seat.

In use, the holes 16 are positioned in the first plate 12 and are configured to accept mounting hardware, such as screws, to couple the first plate 12 to the interior surface of the vehicle. The connector 34 is positioned on the bracket 28 and is configured to couple the bracket 28 to the frame of the seat. The bar 20 is positioned on the first plate 12 and is positioned to pivot. The grasp 22 is positioned on the bar 20 and is positioned to reversibly couple to the bracket 28, which is positioned on the frame of the seat, to prop the seat in a pivoted configuration. Hands-free access is thus permitted to objects that are positioned under the seat, such as a gas tank.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle seat propping device comprising:
a first plate configured for coupling to an interior surface of a vehicle proximate to a hinged seat;
a bar hingedly coupled to and extending from said first plate;
a grasp coupled to said bar distal from said first plate, said grasp being configured to reversibly couple to a frame of the seat when the seat is pivoted; and
wherein said grasp is positioned on said bar such that said grasp is configured for reversibly coupling to the frame of the seat to prop the seat in a pivoted configuration such that hands-free access is permitted to objects positioned under the seat, such as a gas tank.

2. The device of claim 1, further including said first plate being substantially rectangularly shaped.

3. The device of claim 1, further including a coupler coupled to said first plate, said coupler being configured to couple said first plate to the interior surface of the vehicle, wherein said coupler is positioned on said first plate such that said coupler is configured for coupling said first plate to the interior surface of the vehicle.

4. The device of claim 3, further including said coupler comprising a plurality of holes, said plurality of holes being positioned through said first plate, wherein said holes are positioned in said first plate such that said holes are configured for accepting mounting hardware, such as screws, to couple said first plate to the interior surface of the vehicle.

5. The device of claim 4, further including said plurality of holes comprising four said holes evenly distributed and positioned proximate to respective opposing edges of said first plate.

6. The device of claim 1, further including said bar being substantially elongated rectangularly shaped.

7. The device of claim 1, further including said grasp comprising a second plate coupled perpendicularly to a third plate, said bar being coupled to and extending transversely from a junction of said second plate and said third plate.

8. The device of claim 1, further including a bracket configured for coupling to the frame of the seat, said bracket being complementary to said grasp, wherein said bracket is configured for coupling to the frame of the seat such that said bracket is positioned to reversibly couple to said grasp to prop the seat in the pivoted configuration.

9. The device of claim 8, further including said bracket comprising a fourth plate coupled perpendicularly to a fifth plate.

10. The device of claim 9, further including a connector coupled to said bracket, said connector being configured to couple said bracket to the frame of the seat, wherein said connector is positioned on said bracket such that said connector is configured for coupling said bracket to the frame of the seat.

11. The device of claim 10, further including said connector comprising a plurality of penetrations, said plurality of penetrations being positioned through said bracket, wherein said penetrations are positioned in said bracket such that said penetrations are configured for accepting mounting hardware, such as screws, to couple said bracket to the frame of the seat.

12. The device of claim 11, further including said plurality of penetrations comprising two said penetrations positioned in said fourth plate.

13. The device of claim 10, further including said connector comprising tape having a first face and a second face, said first face and said second face being adhesive, wherein said first face is selectively couplable to an inner face and an outer face of said bracket, such that said second face is configured for coupling said bracket to the frame of the seat.

14. A vehicle seat propping device comprising:
a first plate configured for coupling to an interior surface of a vehicle proximate to a hinged seat, said first plate being substantially rectangularly shaped;
a coupler coupled to said first plate, said coupler being configured to couple said first plate to the interior surface of the vehicle, wherein said coupler is positioned on said first plate such that said coupler is configured for coupling said first plate to the interior surface of the vehicle, said coupler comprising a plurality of holes, said plurality of holes being positioned through said first plate, wherein said holes are positioned in said first plate such that said holes are configured for accepting mounting hardware, such as screws, to couple said first plate to the interior surface of the vehicle, said plurality of holes comprising four said holes evenly distributed and positioned proximate to respective opposing edges of said first plate;
a bar hingedly coupled to and extending from said first plate, said bar being substantially elongated rectangularly shaped;
a grasp coupled to said bar distal from said first plate, said grasp being configured to reversibly couple to a frame of the seat when the seat is pivoted, wherein said grasp is positioned on said bar such that said grasp is configured for reversibly coupling to the frame of the seat to prop the seat in a pivoted configuration such that hands-free access is permitted to objects positioned under the seat, such as a gas tank, said grasp comprising a second plate coupled perpendicularly to a third plate, said bar being coupled to and extending transversely from a junction of said second plate and said third plate;
a bracket configured for coupling to the frame of the seat, said bracket being complementary to said grasp, wherein said bracket is configured for coupling to the frame of the seat such that said bracket is positioned to reversibly couple to said grasp to prop the seat in the pivoted configuration, said bracket comprising a fourth plate coupled perpendicularly to a fifth plate;
a connector coupled to said bracket, said connector being configured to couple said bracket to the frame of the seat, wherein said connector is positioned on said bracket such that said connector is configured for coupling said bracket to the frame of the seat, said connector comprising a plurality of penetrations, said plurality of penetrations being positioned through said bracket, wherein said penetrations are positioned in said bracket such that said penetrations are configured for accepting mounting hardware, such as screws, to couple said bracket to the frame of the seat, said plurality of penetrations comprising two said penetrations positioned in said fourth plate, said connector comprising tape having a first face and a second face, said first face and said second face being adhesive, wherein said first face is selectively couplable to an inner face and an outer face of said bracket, such that said second face is configured for coupling said bracket to the frame of the seat; and
wherein said holes are positioned in said first plate such that said holes are configured for accepting mounting hardware, such as screws, to couple said first plate to the interior surface of the vehicle, wherein said connector is positioned on said bracket such that said connector is configured for coupling said bracket to the frame of the seat, wherein said bar is positioned on said first plate such that said bar is positioned for pivoting, such that said grasp is positioned on said bar such that said grasp is positioned for reversibly coupling to said bracket positioned on the frame of the seat to prop the seat in a pivoted configuration, such that hands-free access is permitted to objects positioned under the seat, such as a gas tank.
